(19) United States
(12) Patent Application Publication
(10) Pub. No.: US 2007/0182374 A1
(43) Pub. Date: Aug. 9, 2007

(54) Method of supplying an AC voltage with a battery pack

(75) Inventors: Huo-Lu Tsai, Taichung Hsien (TW); Joe Yu, Taichung Hsien (TW)

Correspondence Address: PATENTTM.US, P. O. BOX 82788, PORTLAND, OR, 97282-0788, US

(73) Assignee: Huo-Lu TSAI

(21) Appl. No.: 11/343,619

(22) Filed: Jan. 30, 2006

(51) Int. Cl. H02J 7/00

(52) U.S. Cl. 320/129

(57) ABSTRACT

A method of supplying an AC voltage with a battery pack comprises the steps of providing a battery pack having two DC output terminals and two AC power output terminals, producing a low DC voltage by the battery pack, converting the low DC voltage to a high DC voltage, outputting a high DC voltage through the two DC output terminals, and alternately connecting the two AC output terminals to the two DC output terminals with a frequency to produce an AC voltage.

### BACKGROUND OF THE INVENTION

1. Field of the Invention

The present invention relates to a method, and more particularly to a method of supplying an AC voltage with a battery pack.

2. Description of Related Art

The electrical technology has been developed very well. Many kinds of the electrical products are widely applied in people's daily life.

For using the AC power-required electrical products in places where the AC power is unavailable often needs an AC power generator. For DC power required electrical product such as a digital camera or a notebook, a battery pack can supply DC power to these products. However, the battery pack is unable to supply an AC power.

To overcome the shortcomings, the present invention provides a method of supplying an AC voltage with a battery pack to obviate or mitigate the aforementioned problems.

### SUMMARY OF THE INVENTION

The main objective of the present invention is to provide a method of supplying an AC voltage, wherein two AC output terminals are alternately connected to two DC output terminals with a frequency to produce an AC power.

A further objective of the present invention is to provide a method of supplying an AC voltage, wherein the AC output terminals are connected to the DC output terminals before a high DC voltage is transmitted to the DC output terminals to avoid a short circuit between the two AC output terminals.

To accomplish the foregoing objective, the method of supplying an AC voltage with a battery pack in accordance with the present invention comprises the steps of

providing a battery pack having two DC output terminals and two AC power output terminals;

producing a low DC voltage by the battery pack;

converting the low DC voltage to a high DC voltage;

outputting a high DC voltage through the two DC output terminals; and

alternately connecting the two AC output terminals to the two DC output terminals with a frequency to produce an AC voltage.

Other objectives, advantages and novel features of the invention will become more apparent from the following detailed description when taken in conjunction with the accompanying drawings.

### BRIEF DESCRIPTION OF THE DRAWINGS

FIG. 1 is a flowchart of a first embodiment of a method of supplying an AC voltage with a battery pack in accordance with the present invention;

FIG. 2 is a flowchart showing further detailed steps of FIG. 1;

FIGS. 3A and 3B are a flowchart showing further detailed steps of FIG. 2;

FIG. 4 is a circuit diagram of a DC/AC converting circuit; and

FIG. 5 is a timing chart diagram of ACV₀ and the timing switches Ctr1˜Ctr4.

### DETAILED DESCRIPTION OF THE PREFERRED EMBODIMENT

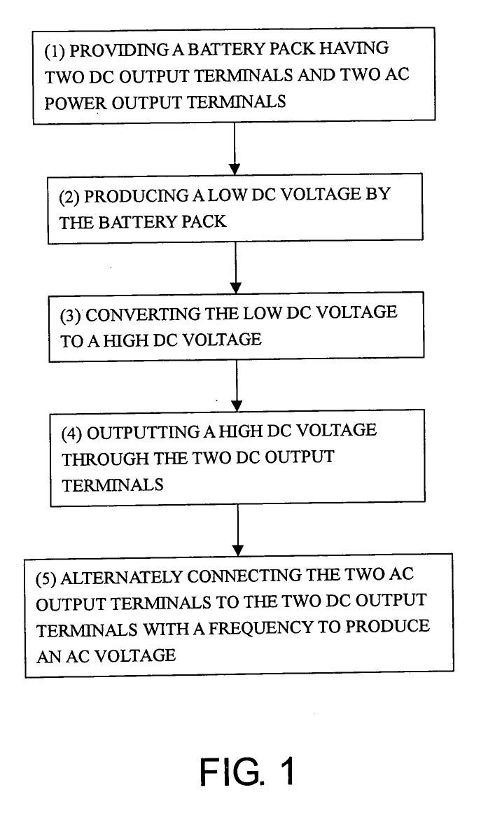

With reference to FIG. 1, a method of supplying an AC voltage with a battery pack in accordance with the present invention comprises the steps of (1) providing a battery pack having two DC output terminals and two AC power output terminals, (2) producing a low DC voltage by the battery pack, (3) converting the low DC voltage to a high DC voltage, (4) outputting a high DC voltage through the two DC output terminals and (5) alternately connecting the two AC output terminals to the two DC output terminals with a frequency to produce an AC voltage.

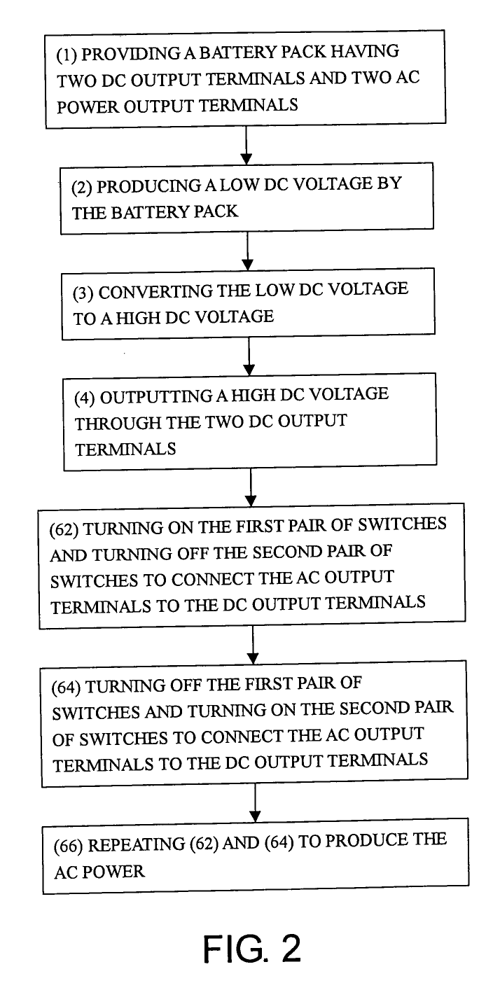

With reference to FIG. 2, in the foregoing step (5), the two AC output terminals are connected to the DC output terminals through two pairs of switches. The step (5) further comprises steps of (62) turning on the first pair of switches and turning off the second pair of switches to connect the AC output terminals to the DC output terminals, (64) turning off the first pair of switches and turning on the second pair of switches to connect the AC output terminals to the DC output terminals and (66) repeating (62) and (64) to produce the AC power.

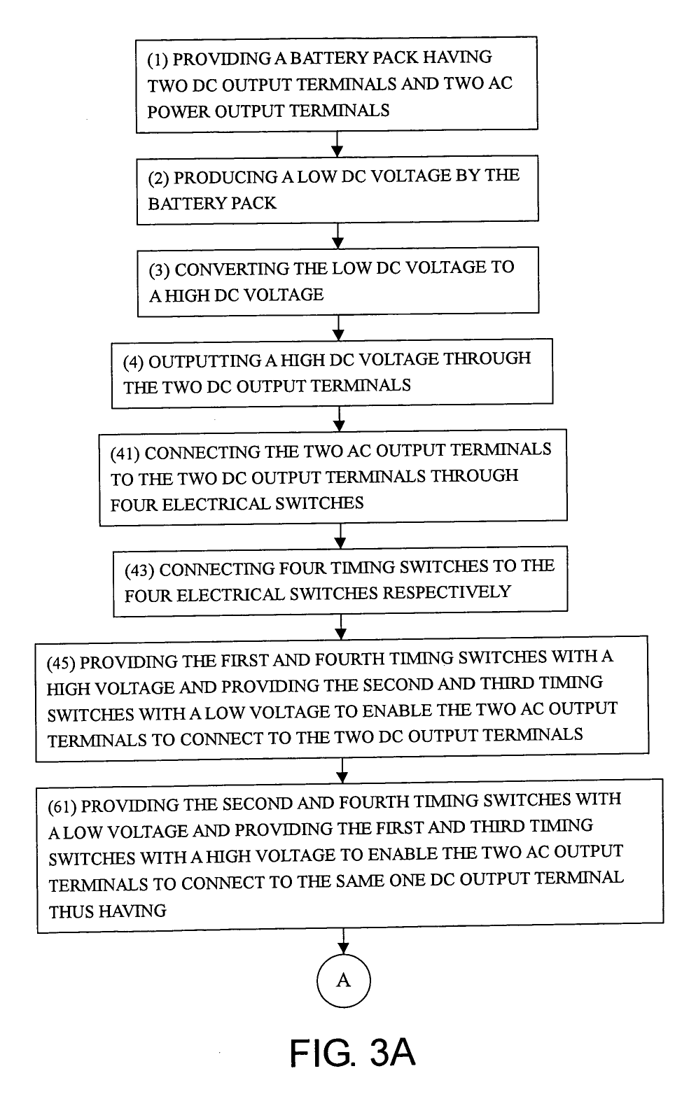

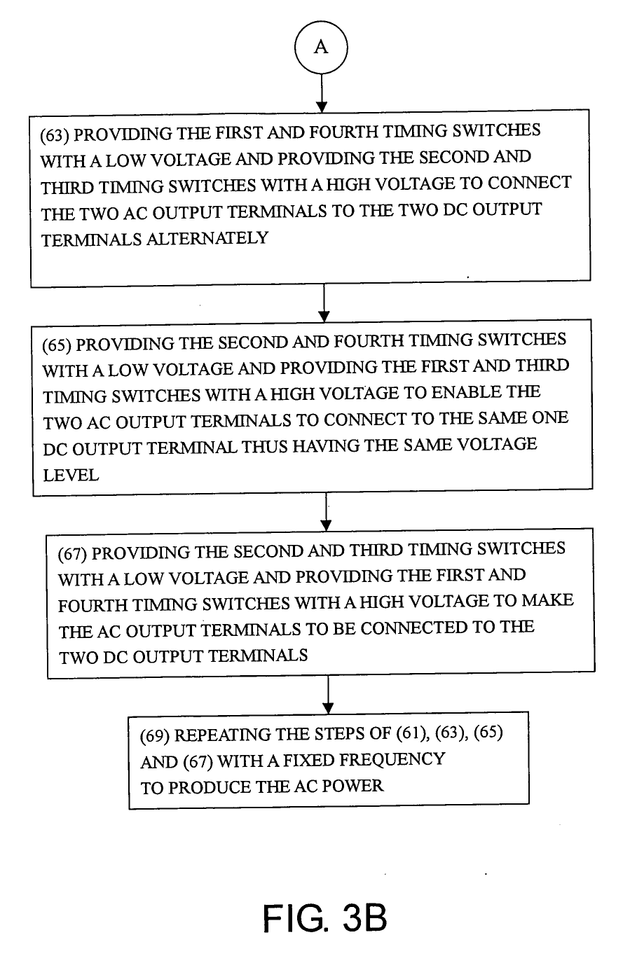

With reference to FIG. 3, in more detail, the foregoing step (5) comprises the following steps. In a step (41), the two AC output terminals are connected to the two DC output terminals through four electrical switches. In a step (43), four timing switches are connected to the four electrical switches respectively. In a step (45), the step is to provide the first and fourth timing switches with a high voltage and provide the second and third timing switches with a low voltage to enable the two AC output terminals to connect to the two DC output terminals. In a step (61), the second and fourth timing switches are provided with a low voltage and the first and third timing switches are provided with a high voltage to enable the two AC output terminals to connect to the same one DC output terminal thus having the same voltage level. In a step (63), the first and fourth timing switches are provided with a low voltage and the second and third timing switches are provided with a high voltage to connect the two AC output terminals to the two DC output terminals alternately. In a step (65), the second and fourth timing switches are provided with a low voltage and the first and third timing switches are provided with a high voltage to enable the two AC output terminals to connect to the same one DC output terminal thus having the same voltage level. In a step (67), the second and third timing switches are provided with a low voltage and the first and fourth timing switches are provided with a high voltage to make the AC output terminals to be connected to the two DC output terminals. In a step (69), the step (61), (63), (65) and (67) are repeated with a fixed frequency.

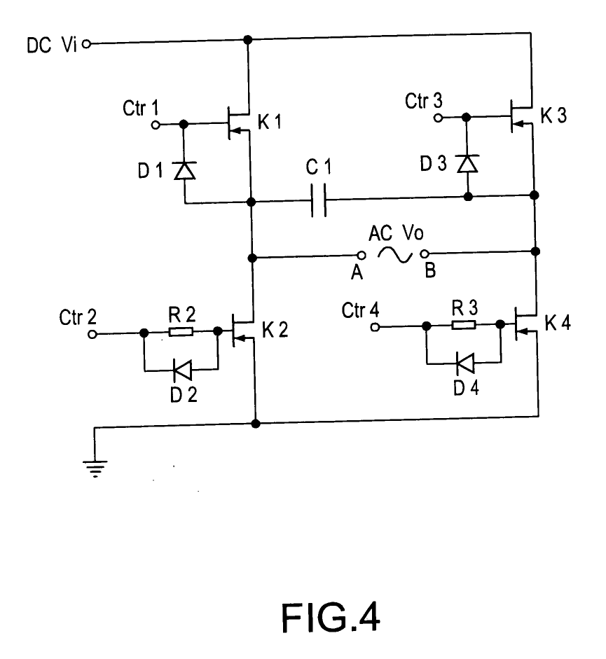

With reference to FIGS. 4, is the circuit diagram of a DC/AC converting circuit to achieve the step (41), (43) and (45), which comprises multiple electrical switches K1˜K4, multiple diodes D1˜D4, a capacitor C1 and multiple resistors R2, R3 and two terminals A, B, wherein

Each electrical switch K1˜K4 can be implemented with the MOSFET.

The two terminals A, B are served as the two output terminals of AC power.

The DCVᵢ and ground terminal are served as the two output terminals of high-voltage DC power.

For the electrical switch K1, the drain is connected to the high DC voltage (DC Vᵢ), the gate is connected to the timing switch Ctr1 and the source is connected to the drain of the electrical switch K2.

For the electrical switch K2, the gate is connected to the timing switch Ctr2, the source is connected to ground and the drain is connected to the source of the electrical switch K1.

For the electrical switch K3, the drain is connected to the high DC voltage (DC Vᵢ), the gate is connected to the timing switch Ctr3 and the source is connected to the drain of the electrical switch K4.

For the electrical switch K4, the gate is connected to the timing switch Ctr4, the source is connected to ground and the drain is connected to the source of the electrical switch K3.

The diode D1 has a positive terminal connected to the source of the electrical switch K1 and the drain of the electrical switch K2 and has a negative terminal connected to the gate of the electrical switch K1 and the timing switch Ctr1.

The diode D2 has a positive terminal connected to the gate of the electrical switch K2 and the resistor R2 and has a negative terminal connected to the resistor R2 and the timing switch Ctr2.

The diode D3 has a positive terminal connected to the source of the electrical switch K3 and the drain of the electrical switch K4 and has a negative terminal connected to the gate of the electrical switch K3 and the timing switch Ctr3.

The diode D4 has a positive terminal connected to the gate of the electrical switch K4 and the resistor R3 and has a negative terminal connected to the resistor R3 and the timing switch Ctr4.

When the electrical switches K1 and K3 are switched off, the electric charge accumulated on the electrical switches K1 and K3 are discharged to ground through the diodes D1 and D3 respectively, wherein the two diodes can speed up the discharge of the two switches K1 and K3.

When the electrical switches K2 and K2 are switched off, the electric charge accumulated on the electrical switches K2 and K4 are discharged through the diodes D2 and D4 respectively, wherein the two diodes D2 and D4 can speed up the discharge of the two switches K2 and K4.

The capacitor C1 is connected to the source of the electrical switch K1 and the drain of the electrical switch K2 to stabilize the current of the AC voltage.

The two terminals A, B are connected to the source of the electrical switch K1 and the drain of the electrical switch K2 to stabilize the output AC current.

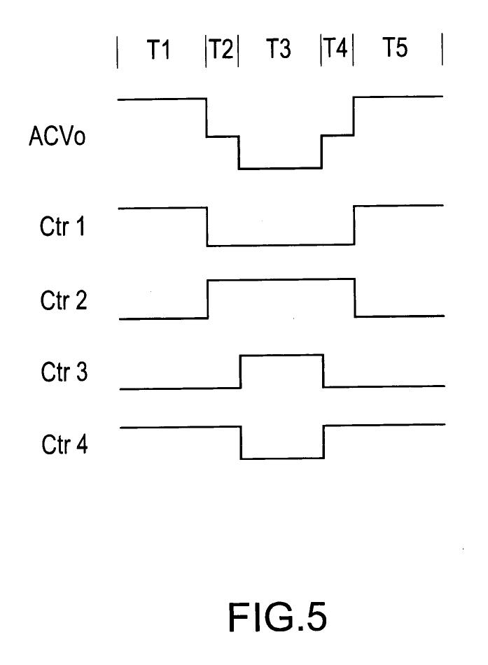

With reference to FIGS. 5, original phase of the driving signals timing switch Ctr1 and Ctr3 are opposite to each other. The driving signal of the timing switch Ctr3 is modified by reducing, for example 5% to 15% , the period of the high-level to form the modified driving signal as illustrated. The phase of the driving signal of the timing switch Ctr2 is opposite to that of the timing switch Ctr1 to prevent the high DC voltage from being contacting to a low voltage terminal such as ground. Similarly, the phase of the driving signal of the timing switch Ctr4 is opposite to that of the timing switch Ctr3.

In T1, the driving signals of the timing switches Ctr1 and Ctr4 are at a high level and the driving signals of the timing switches Ctr2 and Ctr3 are at a low level. The electrical switches K1 and K4 are turned on and the electrical switches K2 and K3 are turned off accordingly. The terminal A of the AC power output terminal (51) is at a high level and the terminal B is connected to ground because of the electrical switch K4, which means the AC power ACV₀ is at a high level (V_{A}>V_{B}).

In T2 and T4, the driving signals of the timing switches Ctr1 and Ctr3 are at a low level and the driving signals of the timing switches Ctr2 and Ctr4 are at a high level. The electrical switches K1 and K3 are turned off and the electrical switches K2 and K4 are turned on accordingly. The terminal A is changed to be connected to ground and the terminal B is also connected to ground. The two terminals A, B are at the same voltage level, which means the AC power ACV₀ is at a zero potential (V_{A}=V_{B}).

In T3, when the driving signals of the timing switches Ctr1 and Ctr4 are at a low level, the driving signals of the timing switches Ctr2 and Ctr3 are at a high level. The electrical switches K1 and K4 are turned off when the electrical switches K2 and K3 are turned on. The terminal A is connected to ground and the terminal B is at a high level, which means the AC power ACV₀ is at a low potential (V_{A}<V_{B}).

During T5, the previous described actions during T1 will be repeated. The repeating frequency of the foregoing operations is 60 Hz or 50 Hz to simulate the sine wave characteristic of an AC power.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A method of supplying an AC voltage with a battery pack comprising the steps of
providing a battery pack having two DC output terminals and two AC power output terminals;
producing a low DC voltage by the battery pack;
converting the low DC voltage to a high DC voltage;
outputting a high DC voltage through the two DC output terminals; and
alternately connecting the two AC output terminals to the two DC output terminals with a frequency to produce an AC voltage.

2. The method as claimed in claim 1, wherein the two AC output terminals are connected to the DC output terminals through two pairs of switches.

3. The method as claimed in claim 2, wherein the step of alternately connecting the two AC output terminals to the two DC output terminalsfurther comprises
turning on the first pair of switches and turning off the second pair of switches to connect the AC output terminals to the DC output terminals;
turning off the first pair of switches and turning on the second pair of switches to connect the AC output terminals to the DC output terminals; and
repeating the two foregoing steps to produce the AC power.

4. The method as claimed in claim 2, wherein the step of alternately connecting the two AC output terminals to the two DC output terminals comprises
connecting the two AC output terminals to the two DC output terminals through four electrical switches;
connecting four timing switches to the four electrical switches respectively;
providing the first and fourth timing switches with a high voltage and providing the second and third timing switches with a low voltage to enable the two AC output terminals to connect to the two DC output terminals;
providing the second and fourth timing switches with a low voltage and providing the first and third timing switches with a high voltage to enable the two AC output terminals to connect to the same one DC output terminal thus having the same voltage level;
providing the first and fourth timing switches with a low voltage and providing the second and third timing switches with a high voltage to connect the two AC output terminals to the two DC output terminals alternately;
providing the second and fourth timing switches with a low voltage and providing the first and third timing switches with a high voltage to enable the two AC output terminals to connect to the same one DC output terminal thus having the same voltage level;
providing the second and third timing switches with a low voltage and providing the first and fourth timing switches with a high voltage to make the AC output terminals to be connected to the two DC output terminals; and
repeating the late four steps with a fixed frequency to produce the AC power.
